(19) United States
(12) Patent Application Publication
(10) Pub. No.: US 2014/0307029 A1
(43) Pub. Date: Oct. 16, 2014

(54) PRINTHEAD INCLUDING TUNED LIQUID CHANNEL MANIFOLD

(71) Applicants: Yonglin Xie, Pittsford, NY (US); Qing Yang, Pittsford, NY (US)

(72) Inventors: Yonglin Xie, Pittsford, NY (US); Qing Yang, Pittsford, NY (US)

(21) Appl. No.: 13/859,813

(22) Filed: Apr. 10, 2013

(51) Int. Cl. B41J 2/14

(52) U.S. Cl. CPC B41J 2/1433
USPC 347/47

(57) ABSTRACT

A continuous liquid ejection printhead includes a plurality of nozzles having a nozzle to nozzle spacing of X. Each nozzle of the plurality of nozzles is in fluid communication with a liquid supply channel through a liquid dispensing channel. The liquid supply channel includes a liquid inlet. The liquid inlets of the liquid supply channels have a center to center inlet to inlet spacing that is greater than X.

### FIELD OF THE INVENTION

This invention relates generally to the field of digitally controlled printing and liquid patterning devices, and in particular to continuous ink jet systems in which a liquid stream breaks into drops, some of which are selectively deflected.

### BACKGROUND OF THE INVENTION

Ink jet printing has become recognized as a prominent contender in the digitally controlled, electronic printing arena because of its non-impact, low-noise characteristics, its use of plain paper and its avoidance of toner transfer and fixing. Ink jet printing mechanisms can be categorized by technology as either drop-on-demand ink jet or continuous ink jet.

The first technology, “drop-on-demand” ink jet printing, provides ink droplets that impact upon a recording surface by using a pressurization actuator (thermal, piezoelectric, etc.). Many commonly practiced drop-on-demand technologies use thermal actuation to eject ink droplets from a nozzle. A heater, located at or near the nozzle, heats the ink sufficiently to boil, forming a vapor bubble that creates enough internal pressure to eject an ink droplet. This form of ink jet is commonly termed “thermal ink jet (TIJ).” Other known drop-on-demand droplet ejection mechanisms include piezoelectric actuators, such as that disclosed in U.S. Pat. No. 5,224,843, issued to van Lintel, on Jul. 6, 1993; thermo-mechanical actuators, such as those disclosed by Jarrold et al., U.S. Pat. No. 6,561,627, issued May 13, 2003; and electrostatic actuators, as described by Fujii et al., U.S. Pat. No. 6,474,784, issued Nov. 5, 2002.

The second technology, commonly referred to as “continuous” ink jet printing, uses a pressurized ink source that produces a continuous stream of ink droplets from a nozzle. The stream is perturbed in some fashion causing it to break up into substantially uniform sized drops at a nominally constant distance, the break-off length, from the nozzle. A charging electrode structure is positioned at the nominally constant break-off point so as to induce a data-dependent amount of electrical charge on the drop at the moment of break-off. The charged droplets are directed through a fixed electrostatic field region causing each droplet to deflect proportionately to its charge. The charge levels established at the break-off point thereby cause drops to travel to a specific location on a recording medium or to a gutter for collection and recirculation.

Continuous ink jet (CIJ) drop generators rely on the physics of an unconstrained fluid jet, first analyzed in two dimensions by F. R. S. (Lord) Rayleigh, “Instability of jets,” Proc. London Math. Soc. 10 (4), published in 1878. Lord Rayleigh's analysis showed that liquid under pressure, P, will stream out of a hole, the nozzle, forming a jet of diameter, dⱼ, moving at a velocity, vⱼ. The jet diameter, dⱼ, is approximately equal to the effective nozzle diameter, D_{dn}, and the jet velocity is proportional to the square root of the reservoir pressure, P. Rayleigh's analysis showed that the jet will naturally break up into drops of varying sizes based on surface waves that have wavelengths, λ, longer than πdⱼ, i.e. λ≧πdⱼ. Rayleigh's analysis also showed that particular surface wavelengths would become dominate if initiated at a large enough magnitude, thereby “synchronizing” the jet to produce mono-sized drops. Continuous ink jet (CIJ) drop generators employ some periodic physical process, a so-called “perturbation” or “stimulation”, that has the effect of establishing a particular, dominant surface wave on the jet. The surface wave grows causing the break-off of the jet into mono-sized drops synchronized to the frequency of the perturbation.

The drop stream that results from applying Rayleigh stimulation will be referred to herein as a stream of drops of predetermined volume as distinguished from the naturally occurring stream of drops of widely varying volume. While in prior art CIJ systems, the drops of interest for printing or patterned layer deposition were invariably of substantially unitary volume, it will be explained that for the present inventions, the stimulation signal may be manipulated to produce drops of predetermined substantial multiples of the unitary volume. Hence the phrase, “streams of drops of predetermined volumes” is inclusive of drop streams that are broken up into drops all having nominally one size or streams broken up into drops of selected (predetermined) different volumes.

In a CIJ system, some drops, usually termed “satellites” much smaller in volume than the predetermined unit volume, may be formed as the stream necks down into a fine ligament of fluid. Such satellites may not be totally predictable or may not always merge with another drop in a predictable fashion, thereby slightly altering the volume of drops intended for printing or patterning. The presence of small, unpredictable satellite drops is, however, inconsequential to the present inventions and is not considered to obviate the fact that the drop sizes have been predetermined by the synchronizing energy signals used in the present inventions. Thus the phrase “predetermined volume” as used to describe the present inventions should be understood to comprehend that some small variation in drop volume about a planned target value may occur due to unpredictable satellite drop formation.

Many commercially practiced CIJ printheads use a piezoelectric device, acoustically coupled to the printhead, to initiate a dominant surface wave on the jet. The coupled piezoelectric device superimposes periodic pressure variations on the base reservoir pressure, causing velocity or flow perturbations that in turn launch synchronizing surface waves. A pioneering disclosure of a piezoelectrically-stimulated CIJ apparatus was made by R. Sweet in U.S. Pat. No. 3,596,275, issued Jul. 27, 1971, Sweet '275 hereinafter. The CIJ apparatus disclosed by Sweet '275 consisted of a single jet, i.e. a single drop generation liquid chamber and a single nozzle structure.

Sweet '275 disclosed several approaches to providing the needed periodic perturbation to the jet to synchronize drop break-off to the perturbation frequency. Sweet '275 discloses a magnetostrictive material affixed to a capillary nozzle enclosed by an electrical coil that is electrically driven at the desired drop generation frequency, vibrating the nozzle, thereby introducing a dominant surface wave perturbation to the jet via the jet velocity. Sweet '275 also discloses a thin ring-electrode positioned to surround but not touch the unbroken fluid jet, just downstream of the nozzle. If the jetted fluid is conductive, and a periodic electric field is applied between the fluid filament and the ring-electrode, the fluid jet may be caused to expand periodically, thereby directly introducing a surface wave perturbation that can synchronize the jet break-off. This CIJ technique is commonly called electrohydrodynamic (EHD) stimulation.

Sweet '275 further disclosed several techniques for applying a synchronizing perturbation by superimposing a pressure variation on the base liquid reservoir pressure that forms the jet. Sweet '275 disclosed a pressurized fluid chamber, the drop generator chamber, having a wall that can be vibrated mechanically at the desired stimulation frequency. Mechanical vibration means disclosed included use of magnetostrictive or piezoelectric transducer drivers or an electromagnetic moving coil. Such mechanical vibration methods are often termed “acoustic stimulation” in the CIJ literature.

The several CIJ stimulation approaches disclosed by Sweet '275 may all be practical in the context of a single jet system However, the selection of a practical stimulation mechanism for a CIJ system having many jets is far more complex. A pioneering disclosure of a multi-jet CIJ printhead has been made by Sweet et al. in U.S. Pat. No. 3,373,437, issued Mar. 12, 1968, Sweet '437 hereinafter. Sweet '437 discloses a CIJ printhead having a common drop generator chamber that communicates with a row (an array) of drop emitting nozzles. A rear wall of the common drop generator chamber is vibrated by means of a magnetostrictive device, thereby modulating the chamber pressure and causing a jet velocity perturbation on every jet of the array of jets.

Since the pioneering CIJ disclosures of Sweet '275 and Sweet '437, most disclosed multi jet CIJ printheads have employed some variation of the jet break-off perturbation means described therein. For example, U.S. Pat. No. 3,560,641 issued Feb. 2, 1971 to Taylor et al. discloses a CIJ printing apparatus having multiple, multi jet arrays wherein the drop break-off stimulation is introduced by means of a vibration device affixed to a high pressure ink supply line that supplies the multiple CIJ printheads. U.S. Pat. No. 3,739,393 issued Jun. 12, 1973 to Lyon et al. discloses a multi jet CIJ array wherein the multiple nozzles are formed as orifices in a single thin nozzle plate and the drop break-off perturbation is provided by vibrating the nozzle plate, an approach akin to the single nozzle vibrator disclosed by Sweet '275. U.S. Pat. No. 3,877,036 issued Apr. 8, 1975 to Loeffler et al. discloses a multi jet CIJ printhead wherein a piezoelectric transducer is bonded to an internal wall of a common drop generator chamber, a combination of the stimulation concepts disclosed by Sweet '437 and '275

Unfortunately, stimulation devices or techniques employing a vibration of some component of the printhead structure or a modulation of the common supply pressure result in some amount of non-uniformity of the magnitude of the perturbation applied to each individual jet of a multi jet CIJ array. Non-uniform stimulation leads to a variability in the break-off length and timing among the jets of the array. This variability in break-off characteristics, in turn, leads to an inability to position a common drop charging assembly or to use a data timing scheme that can serve all of the jets of the array.

In addition to addressing problems of break-off time control among jets of an array, continuous drop emission systems that generate drops in which at least one of the predetermined volume, the drop velocity, breakoff length, or the drop break off phase are based on the liquid-deposition pattern data, commonly called print data, need a means of stimulating each individual jet in an independent fashion in response to the print data. Consequently, in recent years an effort has been made to develop practical “stimulation per jet” apparatus capable of applying individual stimulation signals to individual jets. As will be discussed herein, plural stimulation element apparatus have been successfully developed, however, some inter jet stimulation “crosstalk” problems may remain.

The electrohydrodynamic (EHD) jet stimulation concept disclosed by Sweet '275 operates on the emitted liquid jet filament directly, causing minimal acoustic excitation of the printhead structure itself, thereby avoiding the above noted confounding contributions of printhead and mounting structure resonances. U.S. Pat. No. 4,220,958 issued Sep. 2, 1980 to Crowley discloses a CIJ printer wherein the perturbation is accomplished by an EHD exciter composed of pump electrodes of a length equal to about one-half the droplet spacing. The multiple pump electrodes are spaced at intervals of multiples of about one-half the droplet spacing or wavelength downstream from the nozzles. This arrangement greatly reduces the voltage needed to achieve drop break-off over the configuration disclosed by Sweet '275.

While EHD stimulation has been pursued as an alternative to acoustic stimulation, it has not been applied commercially because of the difficulty in fabricating printhead structures having the very close jet-to-electrode spacing and alignment required and, then, operating reliably without electrostatic breakdown occurring. Also, due to the relatively long range of electric field effects, EHD is not amenable to providing individual stimulation signals to individual jets in an array of closely spaced jets.

An alternate jet perturbation concept that overcomes all of the drawbacks of acoustic or EHD stimulation was disclosed for a single jet CIJ system in U.S. Pat. No. 3,878,519 issued Apr. 15, 1975 to J. Eaton (Eaton hereinafter). Eaton discloses the thermal stimulation of a jet fluid filament by means of localized light energy or by means of a resistive heater located at the nozzle, the point of formation of the fluid jet. Eaton explains that the fluid properties, especially the surface tension, of a heated portion of a jet may be sufficiently changed with respect to an unheated portion to cause a localized change in the diameter of the jet, thereby launching a dominant surface wave if applied at an appropriate frequency. U.S. Pat. No. 4,638,328 issued Jan. 20, 1987 to Drake, et al. (Drake hereinafter) discloses a thermally-stimulated multi-jet CIJ drop generator fabricated in an analogous fashion to a thermal ink jet device. That is, Drake discloses the operation of a traditional thermal ink jet (TIJ) edgeshooter or roofshooter device in CIJ mode by supplying high pressure ink and applying energy pulses to the heaters sufficient to cause synchronized break-off but not so as to generate vapor bubbles.

Also recently, microelectromechanical systems (MEMS), have been disclosed that utilize electromechanical and thermomechanical transducers to generate mechanical energy for performing work. For example, thin film piezoelectric, ferroelectric or electrostrictive materials such as lead zirconate titanate (PZT), lead lanthanum zirconate titanate (PLZT), or lead magnesium niobate titanate (PMNT) may be deposited by sputtering or sol gel techniques to serve as a layer that will expand or contract in response to an applied electric field. See, for example Shimada, et al. in U.S. Pat. No. 6,387,225, issued May 14, 2002; Sumi, et al., in U.S. Pat. No. 6,511,161, issued Jan. 28, 2003; and Miyashita, et al., in U.S. Pat. No. 6,543,107, issued Apr. 8, 2003. Thermomechanical devices utilizing electroresistive materials that have large coefficients of thermal expansion, such as titanium aluminide, have been disclosed as thermal actuators constructed on semiconductor substrates. See, for example, Jarrold et al., U.S. Pat. No. 6,561,627, issued May 13, 2003. Therefore electromechanical devices may also be configured and fabricated using microelectronic processes to provide stimulation energy on a jet-by-jet basis.

U.S. Pat. No. 6,505,921 issued to Chwalek, et al. on Jan. 14, 2003, discloses a method and apparatus whereby a plurality of thermally deflected liquid streams is caused to break up into drops of large and small volumes, hence, large and small cross-sectional areas. Thermal deflection is used to cause smaller drops to be directed out of the plane of the plurality of streams of drops while large drops are allowed to fly along nominal “straight” pathways. In addition, a uniform gas flow is imposed in a direction having velocity components perpendicular and across the array of streams of drops of cross-sectional areas. The perpendicular gas flow velocity components apply more force per mass to drops having smaller cross-sections than to drops having larger cross-sections, resulting in an amplification of the deflection acceleration of the small drops.

U.S. Published Application No. 20100033542 by Piatt, et al., Feb. 11, 2010, discloses a method and apparatus whereby a plurality of liquid streams are caused to breakoff at longer or shorter breakoff lengths in response to the print data, and thereby cause the drops that break off to break off in regions of higher or lower electric field strengths. This yields drops of higher or lower drop charge to be formed. The subsequent deflection of these drops by an electric field causes the trajectories of the higher and lower charge to diverge. A catcher is positioned to intercept the trajectory of one of the higher and lower charged drops while drops travelling along the other trajectory are allowed to strike the print media.

U.S. Pat. No. 7,938,516, issued to Piatt, et al. published on May 10, 2011, discloses a method and apparatus whereby the breakoff phase of drops from a plurality of liquid streams are varied in response to print data, such that certain drops break off while a charge electrode is at a first voltage, and the other drops break off while the charge electrode is at a second voltage. As a result the drops breaking off are charged and subsequently deflected by different amount according to the voltage on the charge electrode at the time of breakoff. A catcher is positioned to intercept the trajectory of the drops charged by one of the first or the second charge plate voltage while drops travelling along the other trajectory are allowed to strike the print media.

U.S. Published Application No. 20120300000 by Panchawagh published on Nov. 29, 2012 discloses an apparatus in which a series pairs of drops are created; one drop of each drop pair breaks off while the charge plate is at a first voltage and the other breaks off while the charge plate is at a second voltage. In response to print data, the relative velocity of the drops in the drop pair can be modulated so that the drops of certain drop pairs merge to form a drop having the combined mass and charge of the individual drops. The drops in the other drop pairs do not merge. The merged and unmerged drops pairs pass through an electric field that causes the merged drops to strike the catcher along with one of the drops of the non-merged drop pairs, while the other drop of the non-merged drop pair is allowed to strike the print media.

Continuous drop emission systems that utilize stimulation per jet apparatus are effective in providing control of the break-up parameters of an individual jet within a large array of jets. The inventors of the present inventions have found, however, that even when the stimulation is highly localized to each jet, for example, via resistive heating at the nozzle exit of each jet, some stimulation crosstalk still propagates as acoustic energy through the liquid via the common supply chambers. The added acoustic stimulation crosstalk from adjacent jets may adversely affect jet break up in terms of breakoff timing, breakoff length, relative drop velocity, or satellite drop formation. When operating in a printing mode of generating different predetermined drop volumes, according to the print data, acoustic stimulation crosstalk may alter the jet break-up producing drops that are not the desired predetermined volume. Especially in the case of systems using multiple predetermined drop volumes, the effects of acoustic stimulation cross talk are data-dependent, leading to complex interactions that are difficult to predict.

Consequently, there is a need to improve the stimulation per jet type of continuous liquid drop emitter by reducing inter-jet acoustic stimulation crosstalk so that the break-up characteristics of individual jets are predictable, and may be relied upon in translating print data into drop generation pulse sequences for the plurality of jets in a large array of continuous drop emitters.

### SUMMARY OF THE INVENTION

According to an aspect of the invention, a continuous liquid ejection printhead includes a plurality of nozzles having a nozzle to nozzle spacing of X. Each nozzle of the plurality of nozzles is in fluid communication with a liquid supply channel through a liquid dispensing channel. The liquid supply channel includes a liquid inlet. The liquid inlets of the liquid supply channels have a center to center inlet to inlet spacing that is greater than X.

### BRIEF DESCRIPTION OF THE DRAWINGS

In the detailed description of the example embodiments of the invention presented below, reference is made to the accompanying drawings, in which:

FIG. 1 shows a simplified block schematic diagram of one exemplary liquid pattern deposition apparatus made in accordance with the present invention;

FIGS. 2a and 2b show schematic plan views of a single thermal stream break-up transducer and a portion of an array of such transducers, respectively, according to a preferred embodiment of the present invention;

FIGS. 3a and 3b show schematic cross-sections illustrating natural break-up and synchronized break-up, respectively, of continuous steams of liquid into drops, respectively;

FIGS. 4a, 4b and 4c show representations of energy pulse sequences for stimulating synchronous break-up of a fluid jet by stream break-up heater resistors resulting in drops of different predetermined volumes according to a preferred embodiment of the present inventions;

FIG. 5 shows a cross-sectional view of a liquid drop emitter operating with large and small drops according to print data;

FIG. 6 shows a cross-sectional view of a portion of an array of continuous drop emitters illustrating the affect of stimulation crosstalk among nearby jets;

FIG. 7 shows a cross-sectional view of two jets of an array of continuous drop emitters illustrating acoustic crosstalk from jet stimulation;

FIGS. 8A and 8B shows two cross-sectional views of a prior art drop generator;

FIGS. 9A, 9C, and 9D show cross-sectional views of an embodiment of the invention along three different cut lines and 9B shows a plan views of a portion of an embodiment of the invention;

FIGS. 10A and 10B show cross-sectional and plan views of a portion of an example embodiment of the invention;

FIGS. 11A and 11B show cross-sectional and plan views of a portion of an example embodiment of the invention;

FIGS. 12A and 12B show cross-sectional and plan views of a portion of an example embodiment of the invention;

FIGS. 13A and 13B show cross-sectional and plan views of a portion of an example embodiment of the invention; and

FIGS. 14A and 14B show cross-sectional and plan views of a portion of an example embodiment of the invention.

### DETAILED DESCRIPTION OF THE INVENTION

The present description will be directed in particular to elements forming part of, or cooperating more directly with, apparatus in accordance with the present invention. It is to be understood that elements not specifically shown or described may take various forms well known to those skilled in the art.

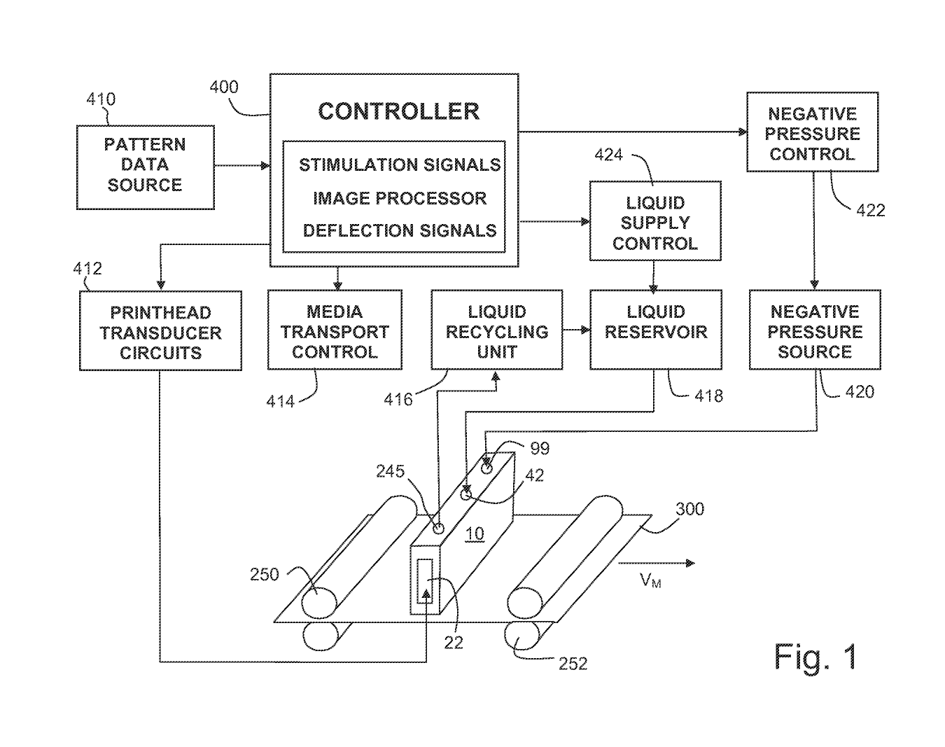

Referring to FIG. 1, a continuous drop emission system for depositing a liquid pattern is illustrated. Typically such systems are ink jet printers and the liquid pattern is an image printed on a receiver sheet or web. However, other liquid patterns can be deposited by the system illustrated including, for example, masking and chemical initiator layers for manufacturing processes. For the purposes of understanding the present inventions the terms “liquid” and “ink” will be used interchangeably, recognizing that inks are typically associated with image printing, a subset of the potential applications of the present inventions. The liquid pattern deposition system is controlled by a process controller 400 that interfaces with various input and output components, computes necessary translations of data and executes needed programs and algorithms.

The liquid pattern deposition system further includes a source of the image or print data 410 which provides raster image data, outline image data in the form of a page description language, or other forms of digital image data. This image data is converted to bitmap image data by controller 400 and stored for transfer to a multi-jet drop emission printhead 10 via a plurality of printhead transducer circuits 412 connected to printhead electrical interface 20. The bit map image data specifies the deposition of individual drops onto the picture elements (pixels) of a two dimensional matrix of positions, equally spaced a pattern raster distance, determined by the desired pattern resolution, i.e. the pattern “dots per inch” or the like. The raster distance or spacing can be equal or can be different in the two dimensions of the pattern.

Controller 400 also creates drop synchronization signals to the printhead transducer circuits that are subsequently applied to printhead 10 to cause the break-up of the plurality of fluid streams emitted into drops of predetermined volume and with a predictable timing. Printhead 10 is illustrated as a “page wide” printhead in that it contains a plurality of jets sufficient to print all scanlines across the medium 300 without need for movement of the printhead itself.

Recording medium 300 is moved relative to printhead 10 by a recording medium transport system, which is electronically controlled by a media transport control system 414, and which in turn is controlled by controller 400. The recording medium transport system shown in FIG. 1 is a schematic representation only; many different mechanical configurations are possible. For example, input transfer roller 250 and output transfer roller 252 could be used in a recording medium transport system to facilitate transfer of the liquid drops to recording medium 300. Such transfer roller technology is well known in the art. In the case of page width printheads as illustrated in FIG. 1, it is most convenient to move recording medium 300 past a stationary printhead. Recording medium 300 is transported at a velocity, V_{M}. In the case of scanning print systems, it is usually most convenient to move the printhead along one axis (the sub-scanning direction) and the recording medium along an orthogonal axis (the main scanning direction) in a relative raster motion. The present inventions are equally applicable to printing systems having moving or stationary printheads and moving or stationary receiving media, and all combinations thereof.

Pattern liquid is contained in a liquid reservoir 418 under pressure. In the non-printing state, continuous drop streams are unable to reach recording medium 300 due to a fluid gutter (not shown) that captures the stream and which can allow a portion of the liquid to be recycled by a liquid recycling unit 416. The liquid recycling unit 416 receives the un-printed liquid via printhead fluid outlet 245, reconditions the liquid and feeds it back to reservoir 418 or stores it. The liquid recycling unit can also be configured to apply a vacuum pressure to printhead fluid outlet 245 to assist in liquid recovery and to affect the gas flow through printhead 10. Such liquid recycling units are well known in the art. The liquid pressure suitable for optimal operation will depend on a number of factors, including geometry and thermal properties of the nozzles and thermal properties of the liquid. A constant liquid pressure can be achieved by applying pressure to liquid reservoir 418 under the control of liquid supply controller 424 that is managed by controller 400.

The liquid is distributed via a liquid supply line entering printhead 10 at liquid inlet port 42. The liquid preferably flows through slots and/or holes etched through a silicon substrate of printhead 10 to its front surface, where a plurality of nozzles and printhead transducers are situated. In some preferred embodiments of the present inventions the printhead transducers are resistive heaters. In other embodiments, more than one transducer per jet can be provided including some combination of resistive heaters, electric field electrodes and microelectromechanical flow valves. When printhead 10 is at least partially fabricated from silicon, it is possible to integrate some portion of the printhead transducer control circuits 412 with the printhead, simplifying printhead electrical connector 22.

A secondary drop deflection apparatus, described in more detail below, can be configured downstream of the liquid drop emission nozzles. This secondary drop deflection apparatus comprises an airflow plenum that generates air flows that impinge individual drops in the plurality of streams of drops flying along predetermined paths based on pattern data. A negative pressure source 420, controlled by the controller 400 through a negative pressure control apparatus 422, is connected to printhead 10 via negative pressure source inlet 99.

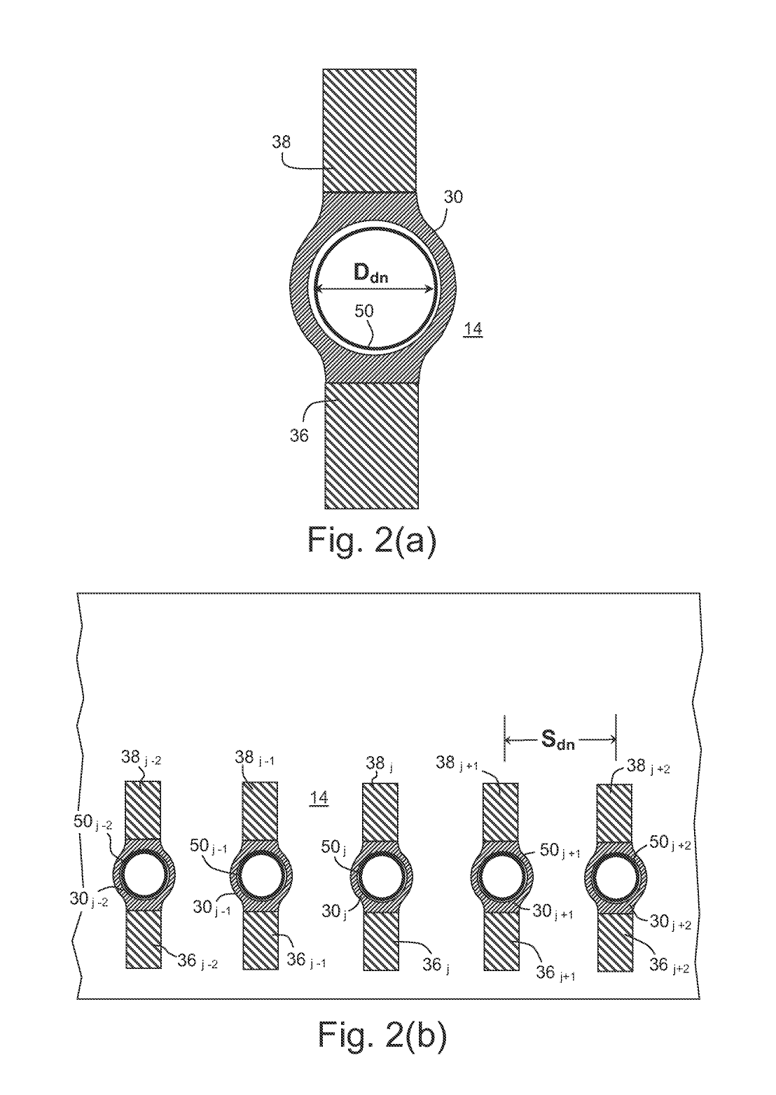

A front face view of a single nozzle 50 of a preferred printhead embodiment is illustrated in FIG. 2a. A portion of an array of such nozzles is illustrated in FIG. 2b. For simplicity of understanding, when multiple jets and component elements are illustrated, suffixes “j”, “j+1”, et cetera, are used to denote the same functional elements, in order, along a large array of such elements. FIGS. 2a and 2b show nozzles 50 of a drop generator portion of printhead 10 having a circular shape with a diameter, D_{dn}, equally spaced at a drop nozzle spacing, S_{dn}, along a nozzle array direction or axis, and formed in a nozzle layer 14. While a circular nozzle is depicted, other shapes for the liquid emission orifice can be used and an effective diameter expressed, for example, the circular diameter that specifies an equivalent open area. Typically the nozzle diameter will be formed in the range of 8 microns to 35 microns, depending on the size of drops that are appropriate for the liquid pattern being deposited. Typically the drop nozzle spacing will be in the range 84 to 21 microns corresponding to a pattern raster resolution in the nozzle axis direction of 300 pixels/inch to 1200 pixels/inch.

An encompassing resistive heater 30 is formed on a front face layer surrounding the nozzle bore. Resistive heater 30 is addressed by electrodes or leads 38 and 36. One of these electrodes 36 can be shared in common with the resistors surrounding other jets. At least one resistor lead 38, however, provides electrical pulses to the jet individually so as to cause the independent stimulation of that jet. Alternatively a matrix addressing arrangement can be employed in which the two address leads 38, 36 are used in conjunction to selectively apply stimulation pulses to a given jet. These same resistive heaters are also utilized to launch a surface wave of the proper wavelength to synchronize the jet of liquid to break-up into drops of substantially uniform diameter, D_{d}, volume, V₀, and spacing λ_{d}. Pulsing schemes can also be devised that cause the break-up of the stream into segments of fluid that coalesce into drops having volumes, Vₘ, that are approximately integer multiples of V₀, i.e. into drops of volume ^{˜}mV₀, where m is an integer.

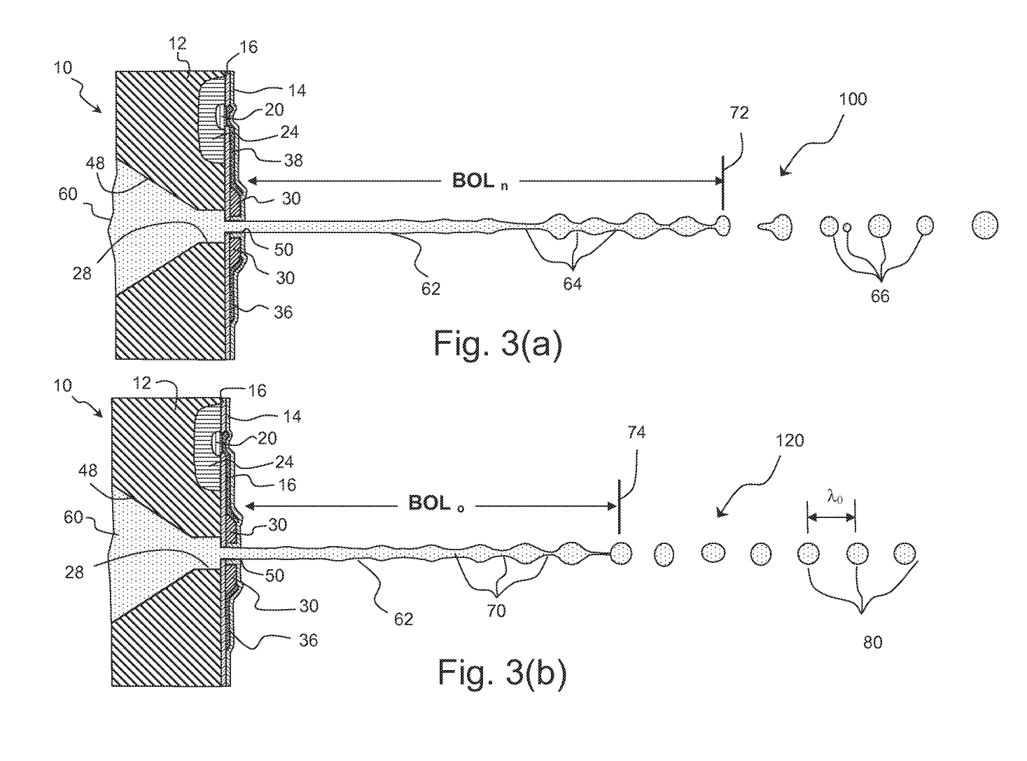

One effect of pulsing nozzle heater 30 on a continuous stream of fluid 62 is illustrated in a side view in FIGS. 3a and 3b. FIGS. 3a and 3b illustrate a portion of a drop generator substrate 12 around one nozzle 50 of the plurality of nozzles. Pressurized fluid 60 is supplied to nozzle 50 via proximate liquid supply chamber 48. Nozzle 50 is formed in drop nozzle front face layer 14, and possibly in thermal and electrical isolation layer 16.

In FIG. 3a, nozzle heater 30 is not energized. Continuous fluid stream 62 forms natural sinuate surface necking 64 of varying spacing resulting in an unsynchronized break-up at location 77 into a stream 100 of drops 66 of widely varying diameter and volume. The natural break-off length, BOLₙ, is defined as the distance from the nozzle face to the point where drops detach from the continuous column of fluid. For this case of natural, unsynchronized break-up, the break-off length, BOLₙ, is not well defined and varies considerably with time.

In FIG. 3b, nozzle heater 30 is pulsed with energy pulses sufficient to launch a dominant surface wave causing dominate surface sinuate necking 70 on the fluid column 62, leading to the synchronization of break-up into a stream 120 of drops 80 of substantially uniform diameter, D_{d}, and spacing, λ₀, and at a stable operating break-off point 76 located an operating distance, BOLₙ, from the nozzle plane. The fluid streams and individual drops 66 and 80 in FIGS. 3a and 3b travel along a nominal flight path at a velocity of V_{d}, based on the fluid pressurization magnitude, nozzle geometry and fluid properties.

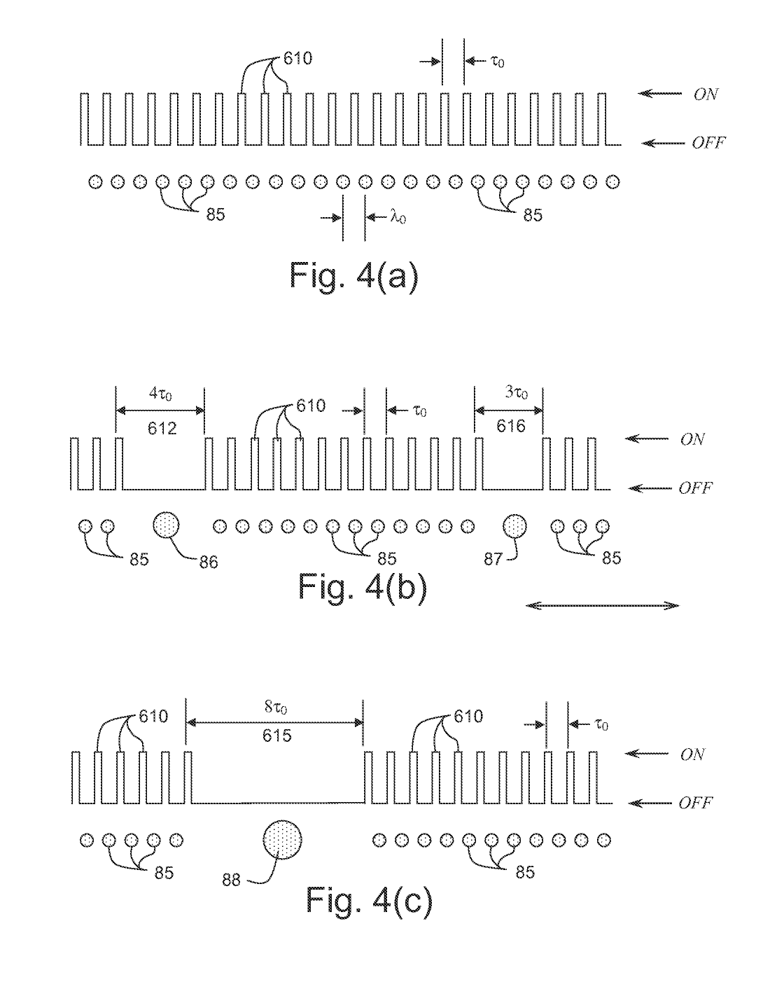

Thermal pulse synchronization of the break-up of continuous liquid jets is also known to provide the capability of generating streams of drops of predetermined volumes wherein some drops can be formed having approximate integer, m, multiple volumes, mV₀, of a unit volume, V₀. See for example U.S. Pat. No. 6,588,888 to Jeanmaire, et al. and assigned to the assignee of the present inventions. FIGS. 4a-4c illustrate thermal stimulation of a continuous stream by several different sequences of electrical energy pulses. The energy pulse sequences are represented schematically as turning a heater resistor “on” and “off” to create a stimulation energy pulse during unit periods, τ₀.

In FIG. 4a, the stimulation pulse sequence consists of a train of unit period pulses 610. A continuous jet stream stimulated by this pulse train is caused to break up into drops 85 all of volume V₀, spaced in time by t₀ and spaced along their flight path by λ₀. The energy pulse train illustrated in FIG. 4b consists of unit period pulses 610 plus the deletion of some pulses creating a 4t time period for sub-sequence 612 and a 3τ₀ time period for sub-sequence 616. The deletion of stimulation pulses causes the fluid in the jet to collect (coalesce) into drops of volumes consistent with these longer than unit time periods. That is, sub-sequence 612 results in the break-off of a drop 86 having coalesced volume of approximately 4V₀ and sub-sequence 616 results in a drop 87 of coalesced volume of approximately 3V₀. FIG. 4c illustrates a pulse train having a sub-sequence of period 8τ₀ generating a drop 88 of coalesced volume of approximately 8V₀. Coalescence of the multiple units of fluid into a single drop requires some travel distance and time from the break-off point. The coalesced drop tends to be located near the center of the space that would have been occupied had the fluid been broken into multiple individual drops of nominal volume V₀.

The capability of producing drops in substantially multiple units of the unit volume V₀ can be used to advantage in differentiating between print and non-printing drops. Drops can be deflected by entraining them in a cross air flow field. Larger drops have a smaller drag to mass ratio and so are deflected less than smaller volume drops in an air flow field. Thus an air deflection zone can be used to disperse drops of different volumes to different flight paths. A liquid pattern deposition system can be configured to print with large volume drops and to gutter small drops, or vice versa.

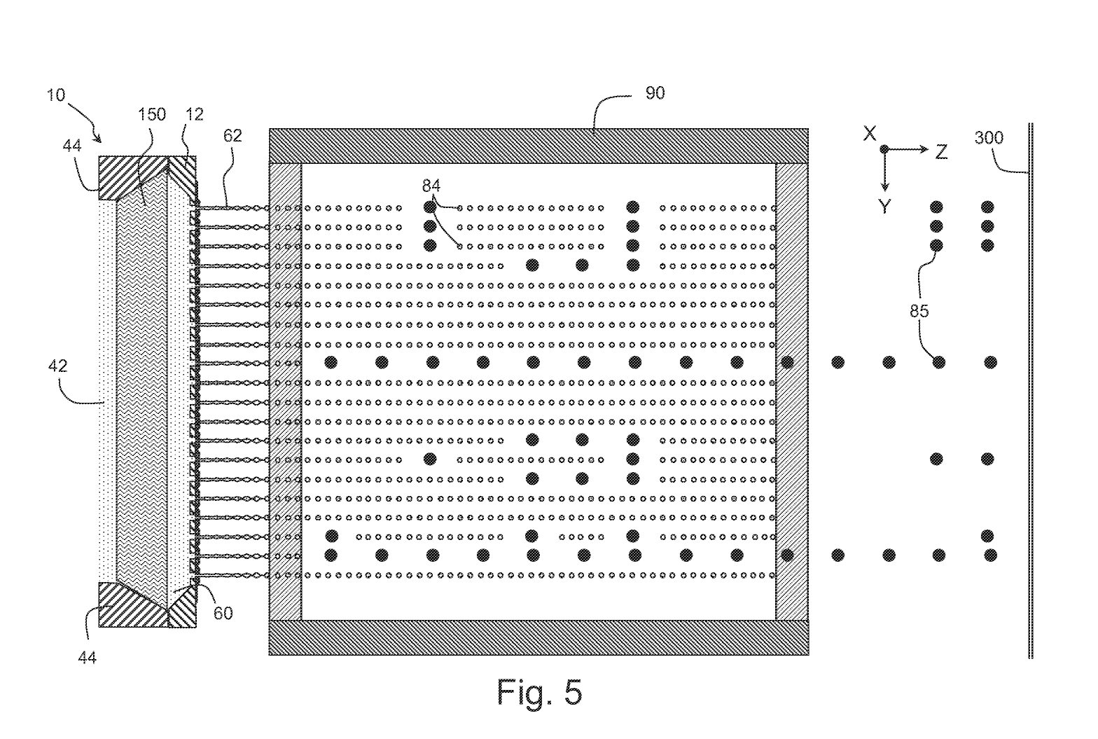

FIG. 5 illustrates in plan cross-sectional view a liquid drop pattern deposition system configured to print with large volume drops 85 and to gutter small volume drops 84 that are subject to deflection airflow in the X-direction, set up by airflow plenum 90. A multiple jet array printhead 10 is comprised of a semiconductor substrate 12 formed with a plurality of jets and jet stimulation transducers attached to a common liquid supply chamber component 44. Patterning liquid 60 is supplied via a liquid supply inlet 42, a slit running the length of the array in the example illustration of FIG. 5. The performance of multi jet drop generator 10 will be discussed below for configurations with and without the incorporation of an acoustic damping structure formed in the semiconductor substrate 12 in order to explain the present inventions. Note that the large drops 85 in FIG. 5 are shown as “coalesced” throughout, whereas in actual practice, the fluid forming large drops 85 often will not coalesce until some distance from the fluid stream break-off point.

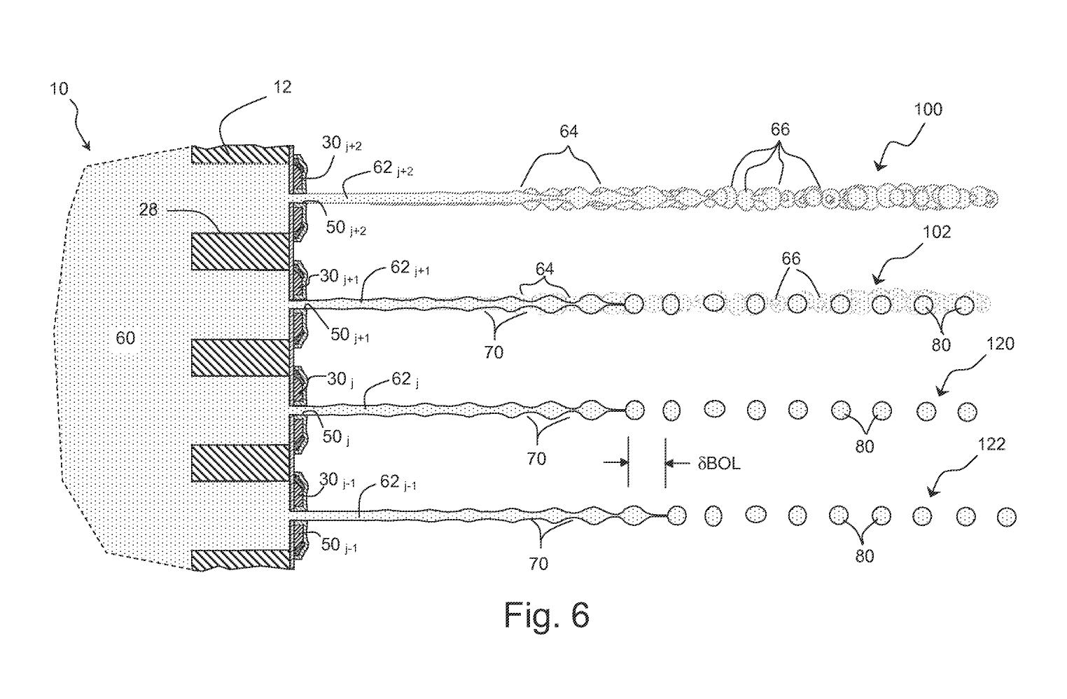

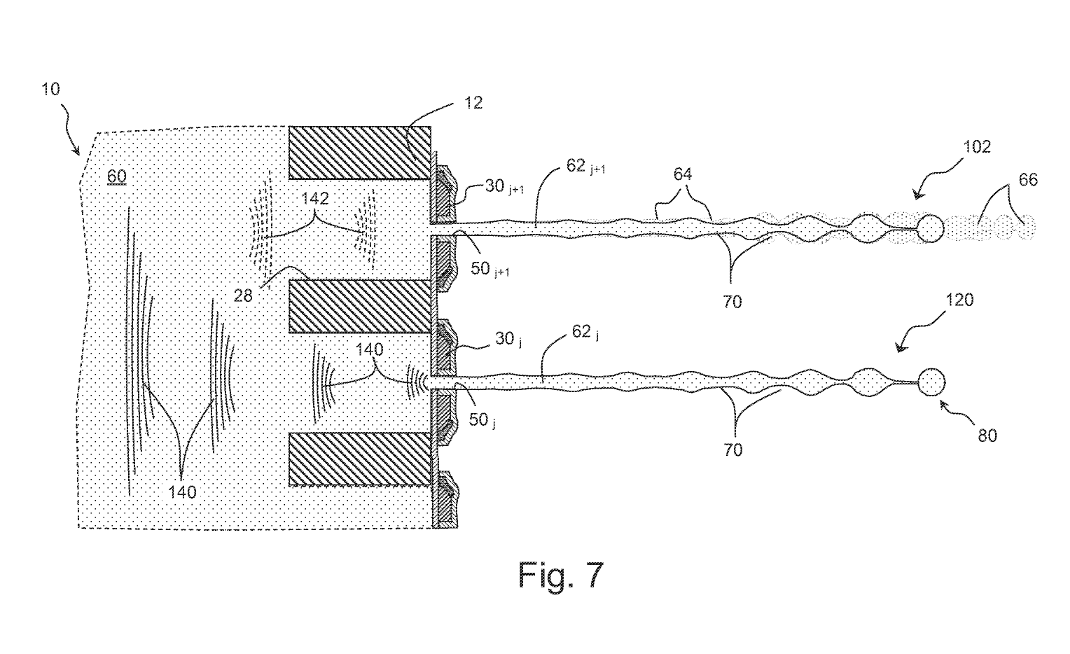

FIG. 6 illustrates in plan cross-sectional view a portion of a prior art multi-jet array including nozzles, streams and heater resistors associated with the j^{th} jet and neighboring jets j+1, j+2 and j−1 along the array (arranged along the Y-direction in FIG. 5). The fluid flow to individual nozzles is partitioned by flow separation features 28, in this case formed as bores in drop generator substrate 12. FIG. 7 illustrates an enlarged view of the two central jets of FIG. 6. The printhead 10 of FIGS. 6 and 7 does not have an acoustic damping structure located in the semiconductor substrate 12. Jets 62ⱼ and 62ⱼ₋₁ are being actively stimulated at a baseline stimulation frequency, f₀, by applying energy pulses to heater resistors 30ⱼ and 30ⱼ₋₁ as described with respect to FIG. 4a, thereby producing mono-volume drops 80 as was discussed previously.

Jets 62ⱼ₊₁ and 62ⱼ₊₂ are not being stimulated by energy pulses to corresponding stimulation resistors 30ⱼ₊₁ and 30ⱼ₊₂. Jet 62ⱼ₊₂ is illustrated as breaking up into drops 66 having a natural dispersion of volumes. However, non-stimulated jet 62ⱼ₊₁, adjacent stimulated jet 62ⱼ, is illustrated as exhibiting a mixture of natural and stimulated jet break-up behavior. The inventors of the present inventions have observed such jet break-up behavior using stroboscopic illumination triggered at a multiple of the fundamental stimulation frequency, f₀. When reflected acoustic stimulation energy 142 is present arising as “crosstalk” from the acoustic energy 140 produced at a nearby stimulated jet, the affected stream shows a higher proportion of drops being generated at the base drop volume, V₀, and drop separation distance, λ₀, than is the case for totally natural break-up. The stroboscopically illuminated image of a jet breaking up naturally is a blur of superimposed drops of random volumes. When a small amount of acoustic stimulation energy 142 at the fundamental frequency, f₀, is added to the fluid flow, because of source acoustic energy 140 propagated in the common supply liquid channels, the image shows a strong stationary ghost image of a stimulated jet superimposed on the blur of the natural break-up. Acoustic stimulation crosstalk also may give rise to differences in break-off length (δ BOL) among stimulated jets as is also illustrated in FIG. 6 as occurring between jets 62ⱼ and 62ⱼ₋₁. Acoustic stimulation crosstalk may adversely affect satellite drop formation. As suggested in this figure, the liquid streams adjacent to the stimulated liquid stream have been observed to have a higher amplitude of the crosstalk stimulation than do the more distant jets; the crosstalk affecting a jet decreases with increasing spacing from the source of the crosstalk.

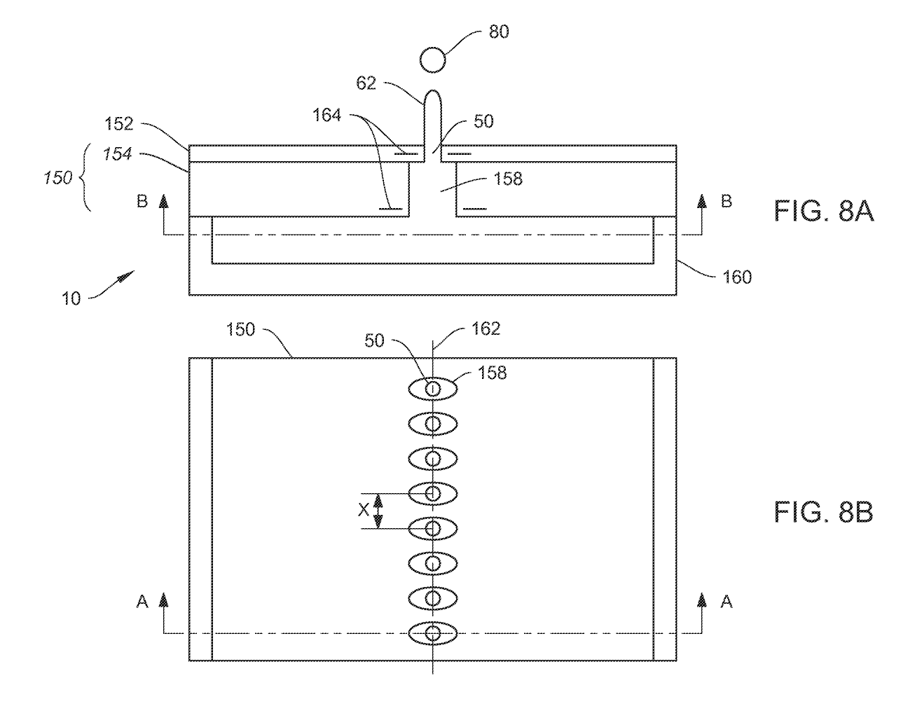

FIG. 8 shows a portion of a prior art nozzle plate structure 150 secured to a fluid manifold 160 of a continuous inkjet printhead 10 with FIG. 8A being a cross sectional view and FIG. 8B being a plan view. The viewing direction of FIG. 8B is denoted by the B-B arrows. FIG. 8B shows the cut line and viewing direction for the FIG. 8A view, denoted by the A-A arrows. The nozzle plate structure 150 is made up of a first substrate layer 154 and a nozzle membrane layer 152. A stream of liquid 63 is shown flowing from a nozzle 50 formed in a nozzle membrane layer 152. Aligned with each nozzle 50, and in fluid communication with it, is a liquid dispensing channel 158; the center axis of the nozzle and the center axis of the liquid dispensing channel being collinear. The liquid dispensing channel extends through the first substrate layer 154 of the nozzle plate structure. The plurality of nozzles are aligned in a linear array, having an axis 162. Ink or other printing fluid from an in reservoir 418 is supplied to the fluid manifold 160 of printhead through a port (not shown). The printing liquid flows through the fluid manifold into the liquid dispensing channels 158 and then out through the nozzles 50 to form streams or jets of liquid from each of the plurality of nozzles 50. The adjacent nozzles 50, along with their associated liquid dispensing channels 158, are spaced apart from each other by a distance X. Drop forming mechanisms 164 associated with each nozzle 50 or liquid dispensing channel 158, such as heater, act on the liquid to induce portions of the liquid jets emanating from the nozzles to break off from the liquid jet to form drops. (The drop forming mechanisms are not shown in the plan view of this or subsequent figures to enable the features related to fluid flow to be more readily seen.)

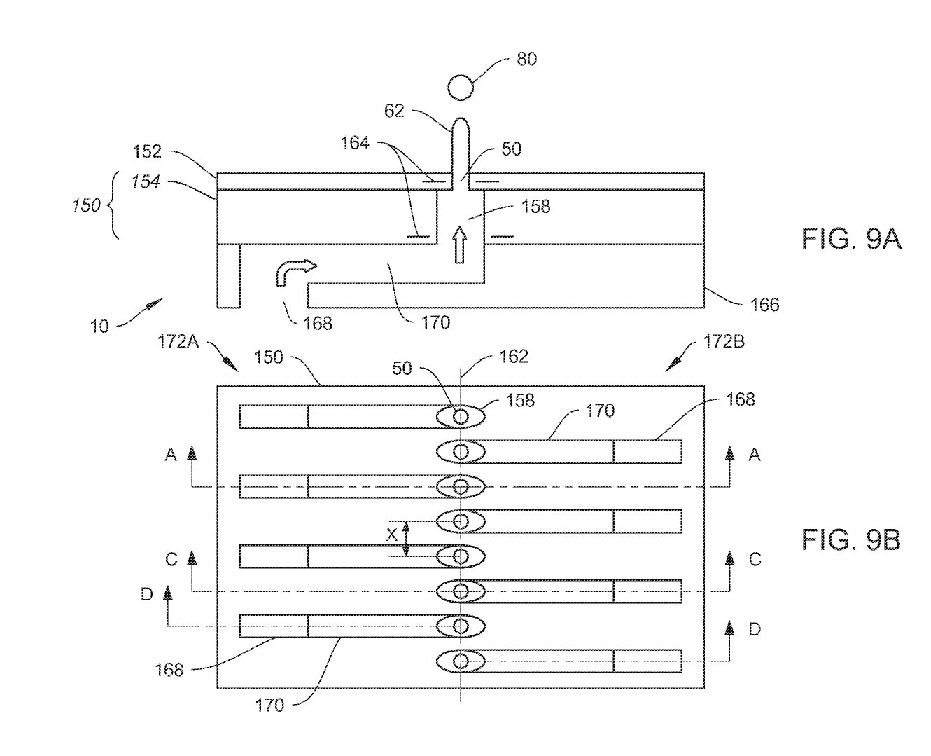

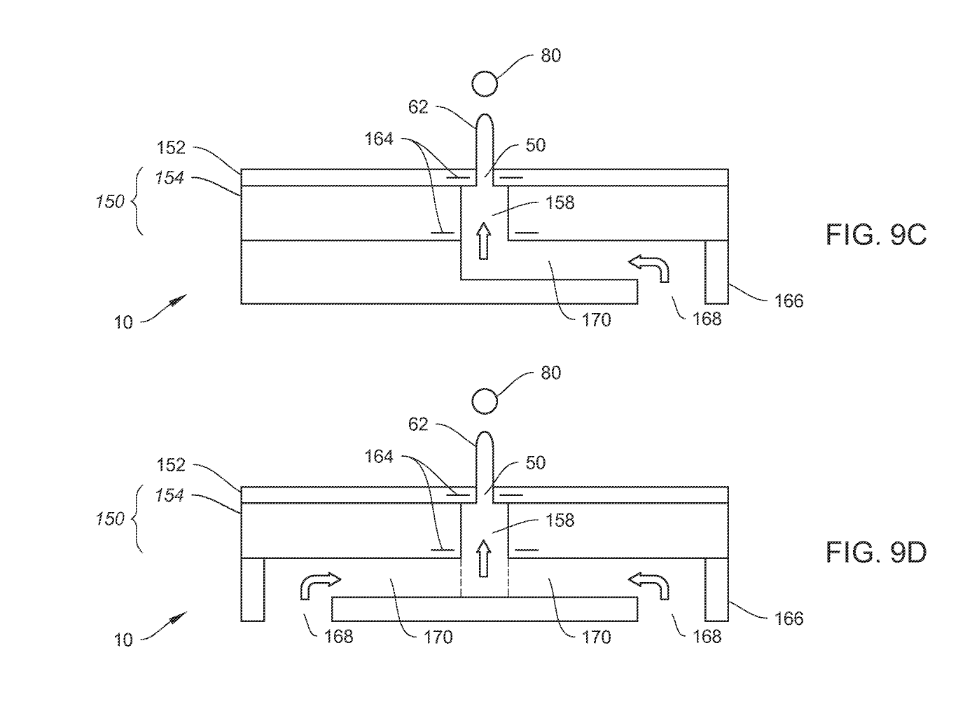

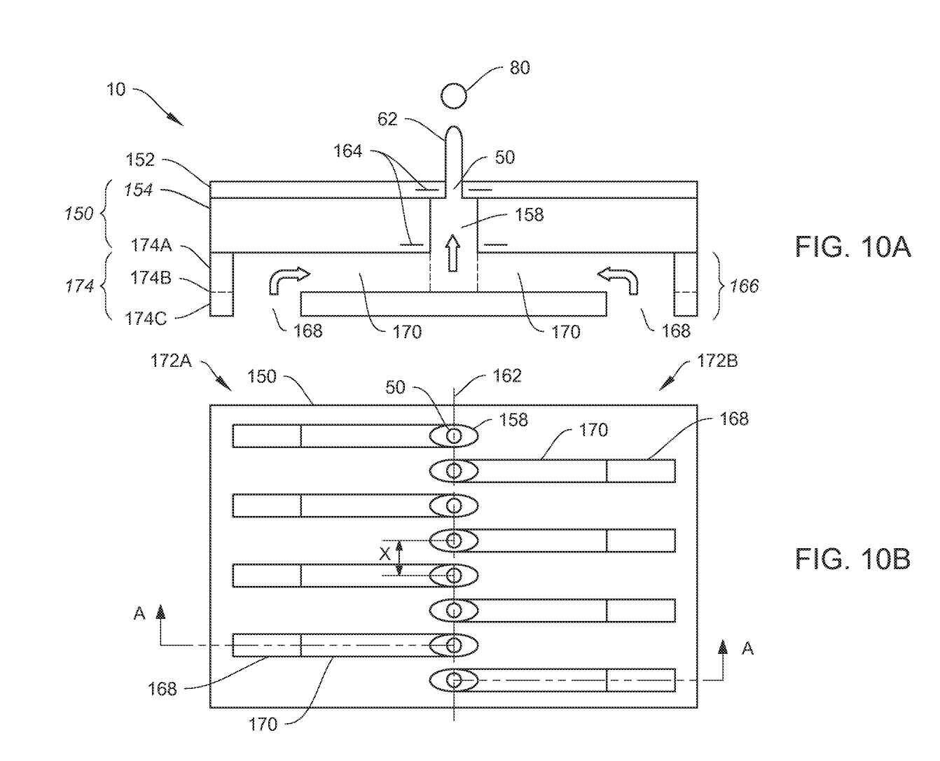

The invention decreases the crosstalk between adjacent nozzles by effectively increasing the spacing between adjacent nozzles. One embodiment of the invention is shown in FIG. 9. FIG. 9B shows a plan view of the nozzle plate structure. It includes cut lines A-A, C-C, and D-D which indicate the cuts for the nozzle plate structure cross-sectional views of FIGS. 9A, 9C, and 9D, respectively. The cross sectional view of FIG. 9D includes an offset at the nozzle array. The cross-sectional views of the other embodiments shown in FIGS. 10-14 have similar offset cut lines. As with the prior art nozzle plate structures, the plurality of nozzles are arranged in a linear array. The nozzles are spaced apart by a distance X. The nozzles are formed in membrane layer 152. Aligned with each nozzle is a liquid dispensing channel 158 formed in and passing through a first substrate 154. The center to center spacing of the liquid dispensing channels 158 is also a distance X. Attached to the first substrate 154 is a second substrate also referred to a liquid distribution layer 166. A plurality of liquid inlets 168, one associated with each of the respective nozzles, pass through the liquid distribution layer 166. The liquid inlets 168 are not arranged in a linear array, but rather are staggered between locations along two rows 172A and 172B. The two rows are located on either side of the axis of the nozzle array 162 and equally spaced from the axis of the nozzle array 162. The liquid inlets each intersect with a liquid supply channel 170. The liquid supply channels 170 extend from the liquid inlets 168 to the liquid dispensing channels 158 to provide fluid communication between a liquid dispensing channel 158 and an associated liquid inlet 168. Preferably the lengths of the liquid supply channels are selected such that acoustic resonance conditions are avoided for the drop formation frequencies being used. This configuration causes the liquid inlets of the liquid supply channels of adjacent nozzles to be offset relative to each other when viewed along the axis of the linear array of nozzles. The liquid supply channels of adjacent nozzles extend in opposite direction relative to each when viewed along the axis of the linear array. As the two rows of liquid inlets are equally spaced from the axis of the linear array of nozzles, and the liquid supply channels have consistent cross sections, the liquid supply channels of adjacent nozzles have the same flow impedance. This helps to ensure that drops produced by adjacent nozzles have the same velocity and momentum. This staggered arrangement of liquid inlets 168 increases the spacing between one liquid inlet and the nearest other liquid inlets. Accordingly, the liquid inlets of the liquid supply channels have a center to center inlet to inlet spacing that is greater than X. As shown in the example embodiment of FIG. 9, the center to center liquid inlet to inlet spacing is 2*X. It should be noted that the adjacent nozzles do not have adjacent liquid inlets, as the liquid inlets associated with adjacent nozzles lie on opposite sides of the nozzle array axis.

The liquid supply channels 170 are formed in the second substrate, the liquid distribution layer 166. The second substrate typically comprises a silicon layer, as does the first substrate 154. The liquid distribution layer 166 can be bonded to the first substrate 154 using an adhesive bonding, an anodic bonding, a eutectic bonding, or other bonding processes know to the skilled in the art. The second substrate can also comprise a polymeric layer. Preferably, the first substrate 154 has sufficient thickness so that the lateral flow velocity of the liquid in the liquid supply channels doesn't produce a significant lateral velocity component to the liquid streams emanating from each nozzle. The level of crosstalk between adjacent nozzles also depends on the fluid impedance between adjacent nozzles. The level of crosstalk is high when the fluid impedance between adjacent nozzles is low. The fluid impedance between the nozzles depends on the cross sectional area and the length of the fluid channel between adjacent nozzles. The fluid impedance between the nozzles is high when the cross sectional area of the fluid channel between adjacent nozzles is small and the length of the fluid channel between adjacent nozzles is long. The continuous inkjet printhead 10 in FIG. 9 has lower cross talk than that in FIG. 8 also because the fluid impedance between adjacent nozzles is lower due to a longer fluid channel length. The fluid channel length associated with each nozzle is extended by the length of the liquid supply channels 170 in FIG. 9.

In the embodiment of FIG. 10, the second substrate 174 comprises an SOI (silicon on insulator) substrate. FIG. 10B shows a plan view of the nozzle plate structure. It includes cut lines A-A, which indicate the jogged cut for the nozzle plate structure cross-sectional views of FIG. 9A. The SOI substrate comprises a first silicon layer 174A and a second silicon layer 174C separated by an insulator layer 174B. The liquid supply channels 170 are etched into the SOI second substrate layer 174A to the depth of the insulator layer 174B, which serves as an etch stop for the DRIE etch used to form the liquid supply channels. The liquid inlets 168 are etched into the opposite face of the SOI second substrate layer 174C and stop at the insulator layer 174B. The exposed insulator layer can then be etched using a different etchant to open up fluid communication between the liquid inlets 168 and the liquid supply channels 170. The SOI second substrate is laminated to the first substrate to complete the formation of the nozzle plate structure.

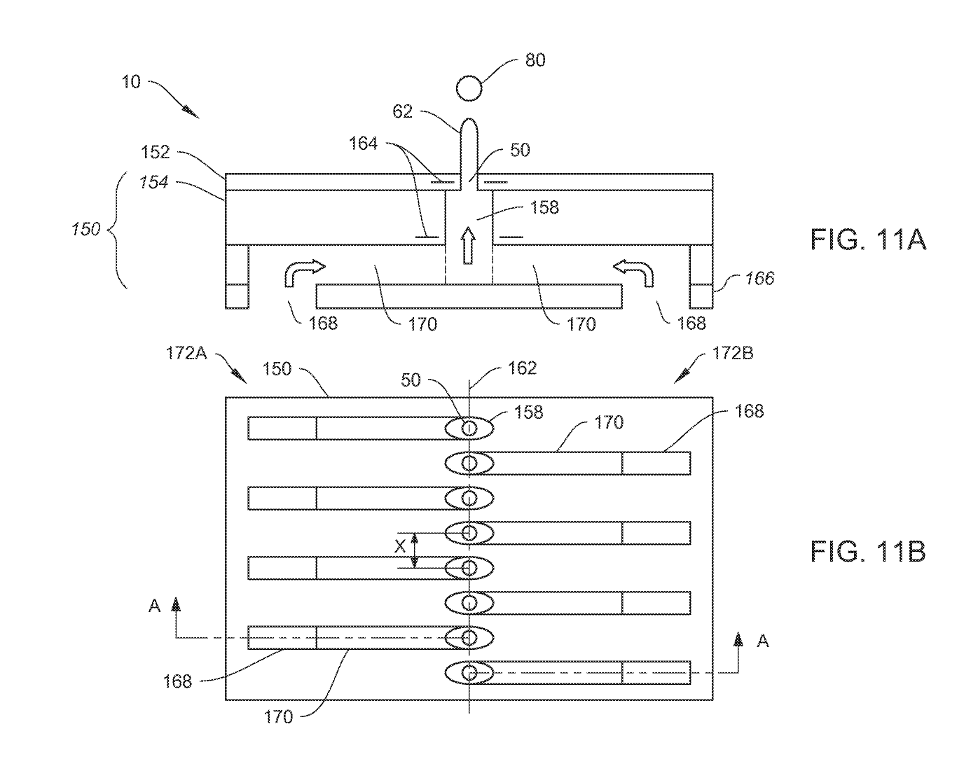

FIG. 11B shows a plan view of another embodiment of the nozzle plate structure. It includes cut lines A-A, which indicate the jogged cut for the nozzle plate structure cross-sectional views of FIG. 11A. In the embodiment of FIG. 11, the liquid supply channels 170 are etched into the first substrate 154 rather than into second substrate 166. The second substrate 166 including the liquid inlets 168, is bonded to the first substrate to form the nozzle plate structure.

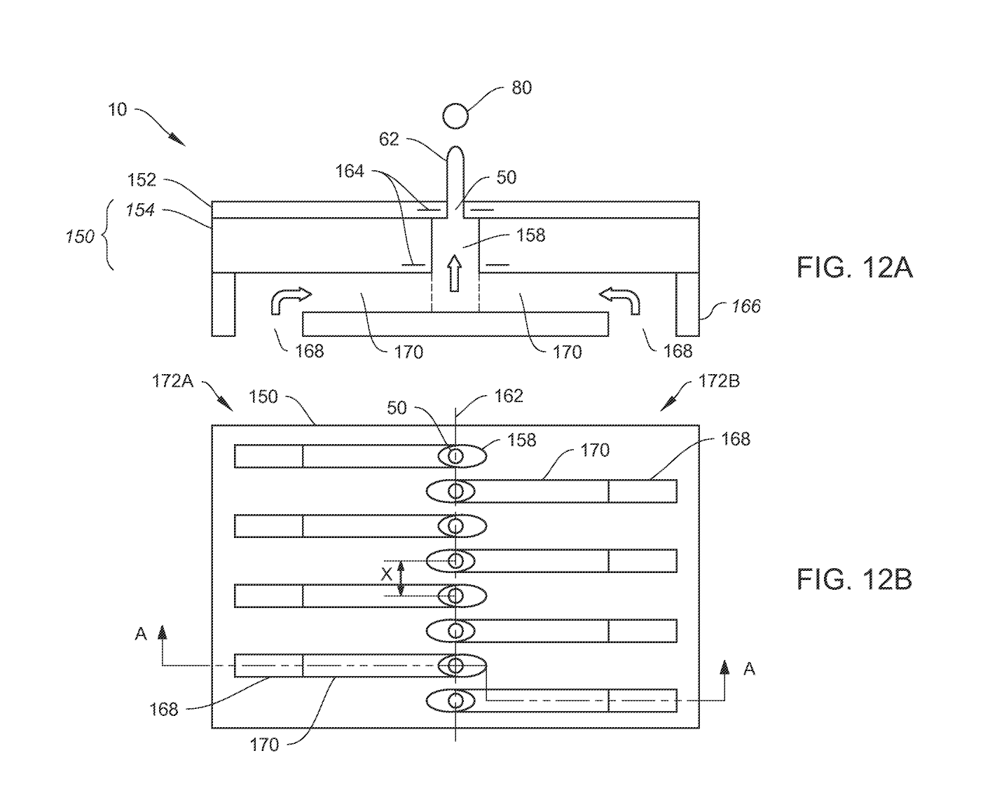

FIG. 12B shows a plan view of another embodiment of the nozzle plate structure. It includes cut lines A-A, which indicate the jogged cut for the nozzle plate structure cross-sectional views of FIG. 12A. In the embodiment of FIG. 12, the center axis of the liquid dispensing channels 158 are not aligned collinear with the center axis of the nozzles 50, but rather the liquid dispensing channels 158 are asymmetrically placed relative to the nozzles 50. The asymmetric placement of liquid dispensing channels alters the directionality of the jets emanating from each nozzle. The amount of offset of the liquid dispensing channels 158 relative to the axis of the nozzles 50 is preferably selected to compensate for the lateral flow velocity in the liquid supply channels 170 such that the jets 62 emerging from each of the nozzles are parallel to each other.

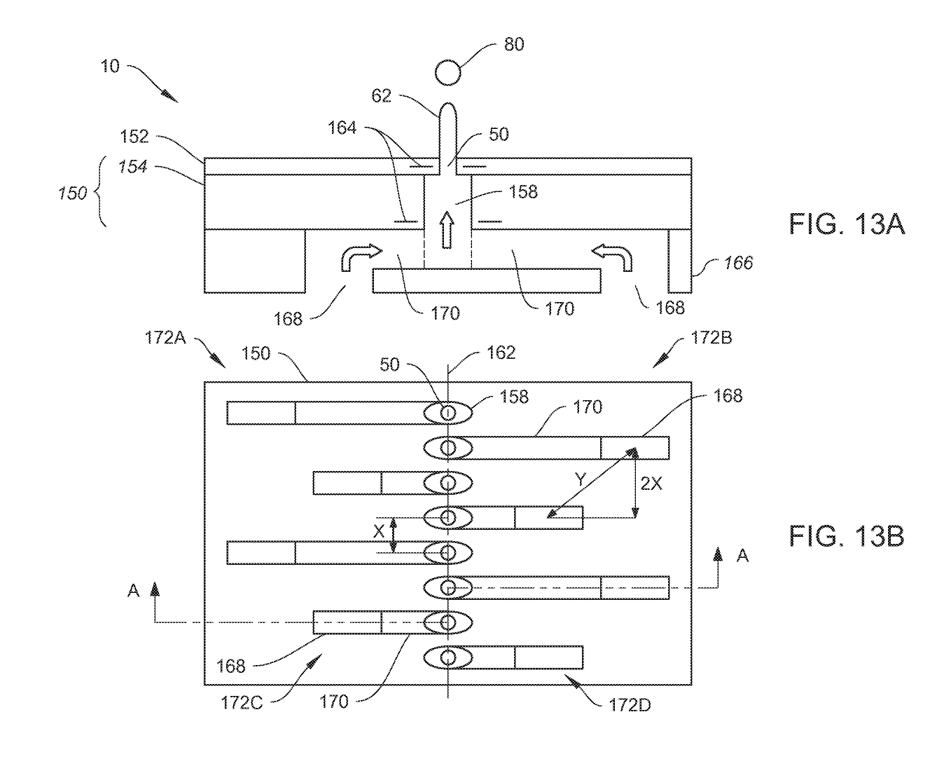

FIG. 13B shows a plan view of another embodiment of the nozzle plate structure. It includes cut lines A-A, which indicate the jogged cut for the nozzle plate structure cross-sectional views of FIG. 13A. The embodiment of FIG. 13, distributes the liquid inlets among more two rows; four rows of liquid inlets 172A-172D are shown. Like the previous embodiments the liquid inlets associated with adjacent nozzles being located on opposite sides of the nozzle array axis 162 with the liquid supply channels of adjacent nozzles extending in opposite directions relative to each other when views along the linear array of nozzles. The liquid supply channels 170 vary in length such that the liquid inlets 186 of adjacent liquid supply channels on the same side of the nozzle array axis 162 are spaced away from the nozzle array axis 162 by different amounts. Adjacent liquid inlets on the same side of the nozzle array are staggered between a row of inlets spaced a first distance from the nozzle array axis and a row of inlets spaced a second distance from the nozzle array axis. As with the earlier embodiments, liquid inlets of the liquid supply channels of adjacent nozzles are offset relative to each other when viewed along the linear array. This embodiment provides an increased liquid inlet to liquid inlet spacing, for comparable row spacings between the outer rows of liquid inlets, when compared to the embodiment of FIG. 9. This staggered arrangement of liquid inlets 168 further increases the spacing between one liquid inlet and the nearest other liquid inlets. The smallest liquid inlet to inlet spacing is Y>2*X in this embodiment. It should be noted that the adjacent nozzles do not have adjacent liquid inlets, as the liquid inlets associated with adjacent nozzles lie on opposite sides of the nozzle array axis. While two lengths of liquid supply channels 170 are shown in FIG. 13, it is anticipated that embodiments have three or more lengths of the liquid supply channels 170 can be used.

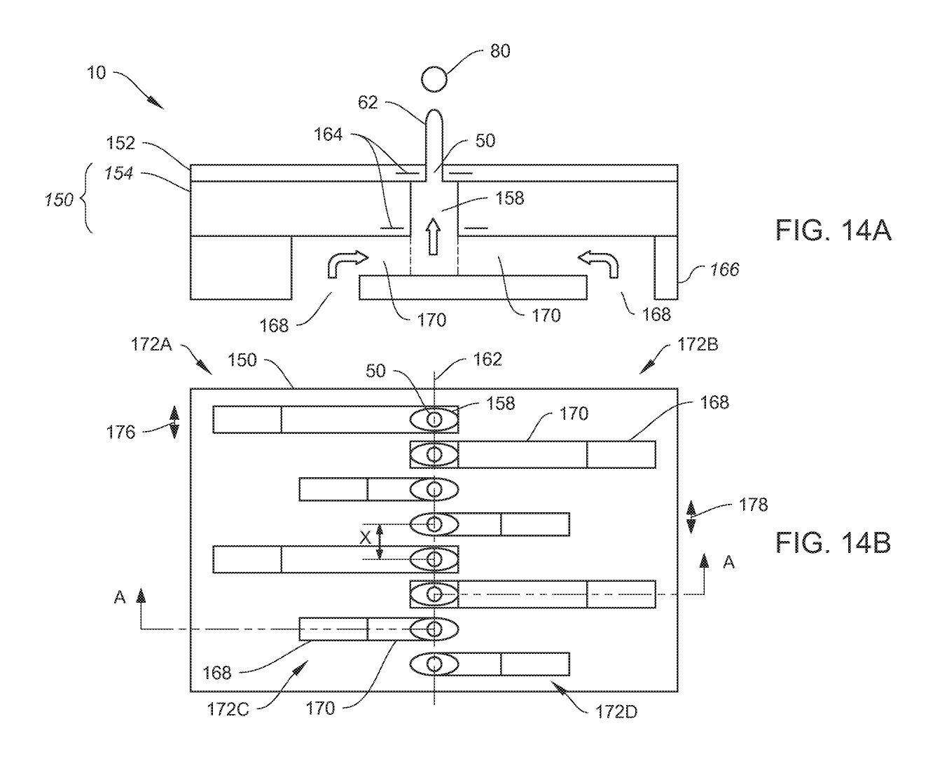

FIG. 14B shows a plan view of another embodiment of the nozzle plate structure. It includes cut lines A-A, which indicate the jogged cut for the nozzle plate structure cross-sectional views of FIG. 14A. The embodiment of FIG. 14 is similar to the embodiment of FIG. 13, in that the liquid supply channels not only alternate in direction relative to the axis 162 of the nozzle array, but also vary in length. In this embodiment, the cross sectional area of the liquid supply channels 170 varies to compensate for the different lengths of the liquid supply channels. The larger cross sectional area, produced for example by increasing the width 176, of the longer liquid supply channels 170 relative to the cross-sectional area, produced for example by decreasing the width 178 of the shorter liquid supply channels 170, the flow impedance of the longer liquid supply channels can be reduced to equal the flow impedance of the shorter liquid supply channels 170. This enables the liquid supply channels of adjacent nozzles to have the same fluid impedance as each other. By making the flow impedances equal, this embodiment reduces the risk of drop velocity differences between drops from different nozzles.

The invention has been described in detail with particular reference to certain preferred embodiments thereof, but it will be understood that variations and modifications can be effected within the scope of the invention.

### PARTS LIST

10 continuous liquid drop emission printhead
12 drop generator substrate
14 drop nozzle front face layer
16 passivation layer
20 via contact to power transistor
22 printhead electrical connector
24 individual transistor per jet to power heat pulses
28 flow separation feature
30 thermal stimulation heater resistor surrounding nozzle
36 heater lead
38 heater lead
42 pressurized liquid supply inlet
44 Liquid chamber component
48 common liquid supply chamber
50 nozzle
60 pressurized liquid
62 continuous stream of liquid
64 natural sinuate surface necking on the continuous stream of liquid
66 drops of undetermined volume
70 stimulated sinuate surface necking on the continuous stream of liquid
72 natural (unstimulated) break-off length
80 drops of predetermined volume
84 drops of small volume, ˜V₀, unitary volume drop
85 large volume drops having volume ˜5 V₀
86 large volume drops having volume ˜4 V₀
87 large volume drops having volume ˜3 V₀
88 large volume drops having volume ˜8 V₀
90 airflow plenum for drop deflection (towards the X-direction)
99 negative pressure source inlet
100 stream of drops of undetermined volume from natural break-up
102 stream of drops of undetermined volume from natural break-up mixed with some drops of pre-determined volume due to acoustic crosstalk
120 stream of drops of pre-determined volume with one level of stimulation
122 stream of drops of pre-determined volume with one level of stimulation
140 sound waves generated in the fluid by jet stimulation
142 reflected or scattered sound waves causing inter-jet stimulation (crosstalk)
150 nozzle plate structure
152 membrane layer
154 first substrate
158 liquid dispensing channel
160 fluid manifold
162 axis
164 drop forming mechanism
166 liquid distribution layer
168 liquid inlet
170 liquid supply channel
172 row
174 SOI substrate
176 Width
178 Width

1. A continuous liquid ejection printhead comprising:
a plurality of nozzles, the plurality of nozzles having a nozzle to nozzle spacing of X, each nozzle of the plurality of nozzles having an associated liquid dispensing channel, an associated liquid supply channel and an associated liquid inlet, each nozzle being in fluid communication with a the associated liquid supply channel through the associated liquid dispensing channel, the associated liquid supply being in fluid communication with the associated liquid inlet, wherein the nearest liquid inlets of the liquid supply channels have a center to center liquid inlet to liquid inlet spacing that is greater than X.

2. The printhead of claim 1, the plurality of nozzles being arranged in a linear array, wherein the liquid inlets of the liquid supply channels of adjacent nozzles are offset relative to each other when viewed along the linear array.

3. The printhead of claim 2, wherein the liquid supply channels of adjacent nozzles extend in opposite directions relative to each other when viewed along the linear array.

4. The printhead of claim 2, each liquid supply channel having a fluid impedance, wherein the liquid supply channels of adjacent nozzles have the same fluid impedance.

5. The printhead of claim 1, each liquid supply channel having a fluid impedance, wherein the liquid supply channels of the plurality of nozzles have the same fluid impedance.

6. The printhead of claim 5, the plurality of nozzles being arranged in a linear array, wherein the liquid supply channels of adjacent nozzles extend in opposite directions relative to each other when viewed along the linear array.

7. The printhead of claim 1, the plurality of nozzles being arranged in a linear array, wherein the liquid supply channels of adjacent nozzles extend in opposite directions relative to each other when viewed along the linear array.

8. The printhead of claim 1, each of the plurality of nozzles having a nozzle axis, wherein the liquid inlet of the liquid supply channel in fluid communication with the nozzle is offset relative to the axis of the nozzle.

9. The printhead of claim 1, the liquid dispensing channel being formed in a first substrate, the inlet of the liquid supply channel being formed in a second substrate, the first substrate and the second substrate being laminated together.

10. The printhead of claim 9, wherein at least a portion of the liquid supply channel in addition to the inlet of the liquid supply channel is formed in the second substrate.

11. The printhead of claim 9, wherein at least a portion of the liquid supply channel is formed in the first substrate.

12. The printhead of claim 1, further comprising:
a liquid supply that provides a liquid at a pressure sufficient to cause a jet of the liquid to be ejected through the plurality of nozzles; and
a drop forming mechanism associated with each nozzle of the plurality of nozzles, the drop forming mechanism being selectively activated to form a drop from a portion of the liquid jet flowing through the associated nozzle.

13. The printhead of claim 1, further comprising:
a liquid supply that provides a liquid at a pressure sufficient to cause a jet of the liquid to be ejected through the plurality of nozzles.

14. The printhead of claim 1, further comprising:
a drop forming mechanism located in a wall of one of the liquid dispensing channel and the nozzle, the drop forming mechanism being selectively activated to form a drop from a portion of the liquid jet flowing through the associated nozzle.

15. The printhead of claim 14, wherein the drop forming mechanism is a heater.

16. The printhead of claim 1, for a given nozzle, the nozzle having a center axis, the associated liquid dispensing channel having a center axis, wherein the center axis of the nozzle is collinear with the center axis of the liquid dispensing channel.
